(19) United States
(12) Patent Application Publication
(10) Pub. No.: US 2013/0140498 A1
(43) Pub. Date: Jun. 6, 2013

(54) SYSTEMS AND METHODS FOR DISPERSING GRAPHITIC CARBON

(71) Applicant: RHODIA OPERATIONS, Aubervilliers (FR)

(72) Inventors: Ryan MURPHY, New York, NY (US); Ruela Talingting PABALAN, Burlington, NJ (US); Amit SEHGAL, Marlton, NJ (US); Lawrence Alan HOUGH, Philadelphia, PA (US)

(73) Assignee: RHODIA OPERATIONS, Aubervilliers (FR)

(21) Appl. No.: 13/688,985

(22) Filed: Nov. 29, 2012

Related U.S. Application Data
(60) Provisional application No. 61/629,941, filed on Dec. 1, 2011.

(51) Int. Cl. H01B 1/04

(52) U.S. Cl. CPC H01B 1/04; Y10S 977/752; Y10S 977/842; Y10S 977/847; B82Y 40/00
USPC 252/510; 252/500; 977/752; 977/842; 977/847; 977/734; 977/742; 977/750

(57) ABSTRACT

Methods and systems for improved dispersion and solubility of carbon materials such as carbon nanotubes through novel binary solvent blends, which include in some embodiments, a mixture of a dibasic ester blend and DMSO.

### CROSS-REFERENCE TO RELATED APPLICATIONS

This application claims the benefit of U.S. Provisional Application Ser. No. 61/629,941 filed Dec. 1, 2011, herein incorporated by reference.

### FIELD OF INVENTION

This invention relates to methods and systems for dispersing carbon materials and, in particular, to improved dispersion and solubility of graphitic carbon through novel binary solvent blends.

### BACKGROUND OF THE INVENTION

Conductive carbon materials such as graphitic carbon and carbon nanotubes exhibit unique properties, including electrical properties, strength and heat conductive properties. In applications utilizing graphitic carbon materials, however, there are drawbacks as these carbon materials are difficult to disperse in solvent blends, which limit their ability in solvent-based or solvent-required applications. Carbon materials such as single-walled carbon nanotubes tend to bundle in solvent or liquid-based applications which are believed to be attributable to hydrophobic interactions amongst the individual nanotubes.

Most prior art techniques increase graphitic carbon solubility by the use of compatibilizers, polymers, or through chemical functionality that promote solubilization with the solvent phase. The latter is accomplished by use of materials having (a) chemical architectures which specifically interact with the hydrophobic graphitic carbon or are covalently attached to the outer wall of the graphitic carbon as well as (b) equal interaction strength with the solvent phase, thus allowing the normally insoluble graphitic carbon particles to be suspended in a variety of solvents. The drawback to using surfactants or polymer compatibilizers with graphitic carbon materials is that their utilization can drastically negatively affect some of their most desirable properties, namely their macroscopic electronic conductivity. In some instances, this occurs because the polymers or surfactants used are not electrically conductive, so their adsorption to the graphitic carbon surface forms an insulating barrier to electron exchange to its nearest neighbor. This behavior, over a large enough number of junction points, will drastically increase the resistance of the macroscopic network. Furthermore, in the area of mechanical composite materials, the surfactant or polymer compatibilizers are still not totally desired, as they add an additional component to the formulation. This adds increased cost, and possible incompatibility issues with the other materials. Further, current methods to disperse graphitic carbon are based on toxic organic solvents such as N-Methyl-1 Pyrrolidone (NMP), Dimethylformamide (DMF), or Dichloromethane (CHCl₂), which is not desirable due to hazard, health and/or environmental concerns.

### SUMMARY OF THE INVENTION

Due to their unique size and chemical make-up, graphitic carbon particles, such as carbon nanotubes, multi-walled carbon nanotubes (MWCNTs), single-walled carbon nanotubes (SWCNTs), and graphene (collectively sometimes herein referred to as “CNTs”) have been a major focus of research across a myriad of scientific fields, namely next generation energy and engineering materials design.

These materials possess a unique sp² carbon configuration that are believed to manifest in extraordinary macroscopic mechanical strength and electronic properties, making them very attractive for light-weight, strong engineering composites, as well as components for organic electronic applications such as photovoltaics (OPV) and organic light emitting diodes (OLEDs). A major barrier in the use of graphitic carbon materials for novel synthesis and formulation technologies is their poor solubility in almost all common solvent blends, both polar and organic. It is believed that the cause of this insolubility is strong van der Waals interactions between individual CNTs or graphene platelets, which lead to strong aggregation, or bundling that is hard to reverse with pure solvent alone. In this strongly aggregated state, the outstanding mechanical and electronic properties of graphitic carbon systems are strongly suppressed, if not eliminated altogether.

The present invention, in one aspect, is directed to a method of preparing a dispersion of graphitic carbon material in a novel solvent system or blend without the need of (or with only a minimal need of) additives such as compatibilizers, polymers or modification of the chemical structure. Thus, the method comprises or consists essentially of obtaining graphitic carbon and contacting the graphitic carbon with a solvent blend. In some embodiments, the solvent blend can comprise a mixture of a dibasic ester and dimethyl sulfoxide (DMSO); or a mixture of a dibasic ester, DMSO and one or more co-solvents as described herein. In some embodiments, in such a method there is no need to modify the graphitic carbon (such as carbon nanotubes) by, for example, attaching a functional group to such carbon material, or by adding an additive such as a polymer, surfactant or compatibilizer to the solvent blend, or adding the carbon material into a compatibilizer and then later introducing the carbon material and compatibilizer mix to the solvent.

Thus, in one aspect, the present invention is a method for preparing a dispersion of graphitic carbon, comprising: obtaining graphitic carbon and then contacting the graphitic carbon with a solvent blend. The solvent blend in one embodiment comprises a dibasic ester blend and dimethyl sulfoxide.

In one embodiment, the dibasic ester blend is selected from dialkyl methylglutarate, dialkyl ethylsuccinate, dialkyl adipate, dialkyl succinate, dialkyl glutarate or any combination thereof. In another embodiment, the dibasic ester blend comprises a branched dibasic ester and at least one of dialkyl methylgiutarate, dialkyl ethylsuccinate, dialkyl adipate, dialkyl succinate or dialkyl glutarate. In some specific embodiment, the dibasic ester blend comprises two branched dibasic esters of dialkyl methylgiutarate and dialkyl ethylsuccinate and, optionally, a linear dibasic ester of dialkyl adipate.

The graphitic carbon can be selected from graphite, graphene, fullerenes, chemically modified fullerenes, carbon nanotubes, single-walled carbon nanotubes, or multi-walled carbon nanotubes. In some embodiments, the graphitic carbon comprises carbon nanotubes. Typically, the carbon nanotubes are either single-walled carbon nanotubes or multi-walled carbon nanotubes. While described herein is the term functionalized graphitic carbon, it is also understood that graphitic carbon, in another embodiment, can mean graphene, fullerenes, chemically modified fullerenes, carbon nanotubes, single-walled carbon nanotubes, multi-walled carbon nanotubes, and/or any chemically modified versions thereof.

The solvent blend, in one embodiment, comprises (i) a dibasic ester blend, and (ii) one or more polar apriotic solvents. The polar apriotic solvent can be, for example, an organosulfur compound, tetrahydrofuran, ethyl acetate, acetone, acetonitrile, dimethyl sulfoxide or any combination thereof. Typically, the polar apriotic solvent is dimethyl sulfoxide.

The solvent blend typically comprises (i) a dibasic ester blend, and (ii) a blend of dimethyl sulfoxide. In one embodiment, dibasic ester blend and dimethyl sulfoxide can be mixed in any relative amounts, so long as the resulting mixture disperses graphitic carbon such as carbon nanotubes (CNT). In another embodiment, the solvent blend comprises from about 25-75% by weight solvent blend of the dibasic ester blend; and from about 25-75% by weight solvent blend of the dimethyl sulfoxide.

In other embodiments, the solvent blend can further comprise one or more co-solvents. In one aspect, the co-solvent can be selected from: a) a dioxolane compound of formula I:

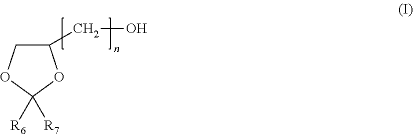

wherein R₆ and R₇, which may be identical or different, is individually a hydrogen, an alkyl group, an alkenyl group, a phenyl group, wherein n is an integer of from 1 to 10;

b) a compound or mixture of compounds having formula (II):

R₃OOC-A-CONR₄R₅ (II),

wherein R₃ is a group chosen from saturated or unsaturated, linear or branched, optionally cyclic, optionally aromatic hydrocarbon-based groups comprising an average number of carbon atoms ranging from 1 to 36; wherein R₄ and R₅, which are identical or different, are groups chosen from saturated or unsaturated, linear or branched, optionally cyclic, optionally aromatic, optionally substituted hydrocarbon-based groups comprising an average number of carbon atoms ranging from 1 to 36; and wherein A is a linear or branched divalent alkyl group comprising an average number of carbon atoms ranging from 2 to 12;

c) an alkyldimethylamine; or

d) any combination thereof, or any combination of a), b) and/or c).

In another aspect, the present invention is a dispersion of graphitic carbon comprising: a) graphitic carbon; and b) a solvent blend comprising (i) a dibasic ester blend, and (ii) dimethyl sulfoxide. In yet another aspect, the present invention is a dispersion of graphitic carbon comprising: a) graphitic carbon; b) a solvent blend comprising (i) a dibasic ester blend, and (ii) dimethyl sulfoxide; and, optionally, c) a co-solvent. In some embodiments, the amount of graphitic carbon in a) is from about 0.001 to 75 wt %. In other embodiments, the amount of graphitic carbon in a) is from about 0.01 to 50 wt %, while in other embodiments, the amount of graphitic carbon is from about 0.05 to 50 wt %. In alternative embodiments, the amount of graphitic carbon is from about 0.01 to 25 wt %.

In another aspect, the present invention is a dispersion of graphitic carbon comprising: a) 0.1 to 25 wt % graphitic carbon; and b) a solvent blend comprising (i) from about 25 to 75 wt %, by weight solvent blend, of a dibasic ester blend, and (ii) from about 25 to 75 wt %, by weight solvent blend, of dimethyl sulfoxide. In yet another aspect, the present invention is a dispersion of graphitic carbon consisting essentially of: a) 0.1 to 25 wt % graphitic carbon; and b) a solvent blend comprising (i) from about 25 to 75 wt %, by weight solvent blend, of a dibasic ester blend, (ii) from about 25 to 75 wt %, by weight solvent blend, of dimethyl sulfoxide.

The present invention, in a further aspect, is a dispersion of graphitic carbon comprising or consisting essentially of: a) 0.1 to 25 wt % graphitic carbon; b) a solvent blend comprising (b(i)) from about 25 to 75 wt %, by weight solvent blend, of a dibasic ester blend; and (b(ii)) from about 25 to 75 wt %, by weight solvent blend, of dimethyl sulfoxide; and c) optionally, a co-solvent selected from (c(i)) a dioxolane compound of formula I:

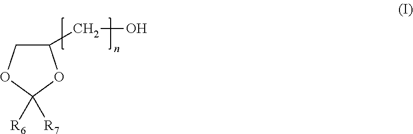

wherein R₆ and R₇, which may be identical or different, is individually a hydrogen, an alkyl group, an alkenyl group, a phenyl group, wherein n is an integer of from 1 to 10; (c(ii)) a compound or mixture of compounds having formula (II):

R₃OOC-A-CONR₄R₅ (II),

wherein R₃ is a group chosen from saturated or unsaturated, linear or branched, optionally cyclic, optionally aromatic hydrocarbon-based groups comprising an average number of carbon atoms ranging from 1 to 36; wherein R₄ and R₅, which are identical or different, are groups chosen from saturated or unsaturated, linear or branched, optionally cyclic, optionally aromatic, optionally substituted hydrocarbon-based groups comprising an average number of carbon atoms ranging from 1 to 36; and wherein A is a linear or branched divalent alkyl group comprising an average number of carbon atoms ranging from 2 to 12; (c(iii)) an alkyldimethylamine; or (c(iv)) any combination thereof.

In yet another aspect, described herein are methods for chemically modifying graphitic carbon, comprising: (a) obtaining graphitic carbon; (b) contacting the graphitic carbon with a solvent blend to create a dispersion, the solvent blend comprising (i) a dibasic ester blend and (ii) a compound selected from the group consisting of an organosulfur compound, tetrahydrofuran, ethyl acetate, acetone, acetonitrile, dimethyl sulfoxide and any combination thereof; and (c) functionalizing the graphitic carbon. The organosulfur compound in one embodiment is dimethyl sulfoxide.

In one embodiment, the step of functionalizing the graphitic carbon comprises a reaction that (i) covalently disrupts, modifies, or alters the bond configuration of a carbon atom of the graphitic carbon in contact with the solvent blend, or (ii) allows non-covalent physisorption of a chemical moiety that is solubilized or partially solubilized in the solvent blend.

In yet another aspect, described herein are methods for chemically modifying graphitic carbon, comprising: (a) obtaining graphene or graphitic carbon; (b) contacting the graphene or graphitic carbon with a solvent blend to create a dispersion, the solvent blend comprising a dibasic ester blend and dimethyl sulfoxide (DMSO); and (c) functionalizing the graphene or graphitic carbon through a reaction that (i) covalently disrupts, modifies, or alters the native sp² bond configuration of carbon atoms within a layer of graphitic carbon in contact with the solvent blend, or (ii) allows non-covalent physisorption of any chemical moiety that is solubilized or partially solubilized in the solvent blend.

In a further aspect, described herein are methods for chemically modifying graphitic carbon or preparing functionalized graphitic carbon material comprising the steps of: (A) obtaining graphitic carbon; (B) contacting the graphitic carbon with a solvent blend to create a dispersion, the solvent blend comprising: (a) a dibasic ester blend, (b) dimethyl sulfoxide (DMSO), and (c) optionally, a co-solvent, the co-solvent selected from:

c(i) a dioxolane compound of formula I:

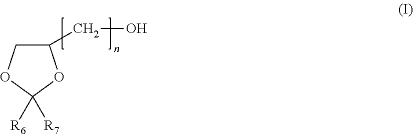

wherein R₆ and R₇, which may be identical or different, is individually a hydrogen, an alkyl group, an alkenyl group, a phenyl group, wherein n is an integer of from 1 to 10;
c(ii) a compound or mixture of compounds having formula (II):

R₃OOC-A-CONR₄R₅ (II),

wherein R₃ is a group chosen from saturated or unsaturated, linear or branched, optionally cyclic, optionally aromatic hydrocarbon-based groups comprising an average number of carbon atoms ranging from 1 to 36;

wherein R₄ and R₅, which are identical or different, are groups chosen from saturated or unsaturated, linear or branched, optionally cyclic, optionally aromatic, optionally substituted hydrocarbon-based groups comprising an average number of carbon atoms ranging from 1 to 36; and

wherein A is a linear or branched divalent alkyl group comprising an average number of carbon atoms ranging from 2 to 12;
c(iii) an alkyldimethylamine; or
c(iv) any combination thereof; and
   (C) functionalizing the graphitic carbon.

### DETAILED DESCRIPTION OF THE INVENTION

As used herein, the term “alkyl” means a saturated or unsaturated straight chain, branched chain, or cyclic hydrocarbon radical, including but not limited to, methyl, ethyl, n-propyl, iso-propyl, butyl, isobutyl, n-butyl, sec-butyl, t-butyl, pentyl, n-hexyl, and cyclohexyl.

As used herein, the term “aryl” means a monovalent unsaturated hydrocarbon radical containing one or more six-membered carbon rings in which the unsaturation may be represented by three conjugated double bonds, which may be substituted one or more of carbons of the ring with hydroxy, alkyl, alkenyl, halo, haloalkyl, or amino, including but not limited to, phenoxy, phenyl, methylphenyl, dimethylphenyl, trimethylphenyl, chlorophenyl, trichloromethylphenyl, aminophenyl, and tristyrylphenyl.

As used herein, the term “alkylene” means a divalent saturated straight or branched chain hydrocarbon radical, such as for example, methylene, dimethylene, trimethylene.

As used herein, the terminology “(Cr-Cs)” in reference to an organic group, wherein r and s are each integers, indicates that the group may contain from r carbon atoms to s carbon atoms per group.

Described herein, in one embodiment, are systems, compositions and methods for improved dispersability of graphitic carbon systems in novel binary solvent systems without the need of compatibilizers or additives that negatively affect the conductive or other properties of the dispersed graphitic carbon. The present invention also addresses the drawbacks of the prior art by through improved dispersability of graphitic carbon materials in a novel binary solvent blend.

In one embodiment, the solvent blend is based on mixture of dimethyl sulfoxide (DMSO) and a blend of dibasic esters, the dibasic ester blend being a mixture of C₁-C₁₂ dialkyl methylglutarate, C₁-C₁₂ dialkyl ethylsuccinate, and, optionally, C₁-C₁₂ dialkyl adipate. In another embodiment, the dibasic ester blend is at least one of: C₁-C₁₂ dialkyl methylglutarate, C₁-C₁₂ dialkyl ethylsuccinate and C₁-C₁₂ dialkyl adipate. In another embodiment, the dibasic ester blend is a mixture of at least two of: C₁-C₁₂ dialkyl methylglutarate, C₁-C₁₂ dialkyl ethylsuccinate and C₁-C₁₂ dialkyl adipate. In another embodiment, the dibasic ester blend is a mixture of at least two of: C₁-C₁₂ dialkyl methylglutarate, C₁-C₁₂ dialkyl ethylsuccinate, C₁-C₁₂ dialkyl glutarate, C₁-C₁₂ dialkyl succinate and/or C₁-C₁₂ dialkyl adipate. In a further embodiment, the dibasic ester blend is a mixture of: (i) dialkyl methylglutarate and (ii) at least one of: C₁-C₁₂ dialkyl ethylsuccinate, C₁-C₁₂ dialkyl glutarate, C₁-C₁₂ dialkyl succinate and/or C₁-C₁₂ dialkyl adipate. In some specific embodiments, the dibasic ester blend is a mixture of: (i) C₁-C₁₂ dialkyl methylglutarate and (ii) dialkyl ethylsuccinate.

In yet another embodiment, the blend is a mixture of: dimethyl 2- methylglutarate present from about 70-95 wt %, more typically, 80-92 wt %, more typically from about 86-90 wt % (of blend), dimethyl ethylsuccinate present from about 3-20 wt %, more typically from about 5-15 wt % (by weight), more typically from about 9-11 wt % (by weight), and, optionally, dimethyl adipate present from about 0-2.5 wt %, more typically, 0-1 wt % (by blend).

In one embodiment, the weight ratio of dibasic ester blend to DMSO can be any weight ratio so long as the resulting mixture disperses graphitic carbon such as carbon nanotubes (CNT). In another embodiment, the weight ratio of dibasic ester blend to DMSO ranges from 1:9 dibasic ester: DMSO to about 9:1 dibasic ester:DMSO, so long as the resulting mixture disperses graphitic carbon such as carbon nanotubes (CNT). In another embodiment, the weight ratio of dibasic ester blend to DMSO ranges from 1:6 dibasic ester: DMSO to about 6:1 dibasic ester:DMSO, so long as the resulting mixture disperses graphitic carbon such as carbon nanotubes (CNT). In another embodiment, the weight ratio of dibasic ester blend to DMSO ranges from 1:2 dibasic ester: DMSO to about 2:1 dibasic ester:DMSO, so long as the resulting mixture disperses graphitic carbon such as carbon nanotubes (CNT). In another embodiment, the weight ratio of dibasic ester blend to DMSO ranges from 1:1.5 dibasic ester:DMSO to about 1.5:1 dibasic ester:DMSO, so long as the resulting mixture disperses graphitic carbon such as carbon nanotubes (CNT). In another embodiment, the weight ratio of dibasic ester blend to DMSO ranges from 1:1.25 dibasic ester:DMSO to about 1.25:1 dibasic ester:DMSO, so long as the resulting mixture disperses graphitic carbon such as carbon nanotubes (CNT). In another embodiment, the weight ratio of dibasic ester blend to DMSO ranges from 1:1.1 dibasic ester:DMSO to about 1.1:1 dibasic ester:DMSO, so long as the resulting mixture disperses graphitic carbon such as carbon nanotubes (CNT). It is understood that the mixture of dibasic ester:DMSO can vary according to the external conditions and fall within any ratio within the ranges of from 1:9 dibasic ester:DMSO to about 9:1 dibasic ester:DMSO. For example, the weight ratio of dibasic ester:DMSO can be 3:5 or 5:3, which falls within the ranges listed above.

In one embodiment, when mixed at an approximately 1:1 weight ratio of dibasic ester blend to DMSO, the resulting mixture disperses carbon nanotubes (CNT) better than NMP, without the use of any cosolubilizing agent such as surfactant, polymer or compatibilizer. In one particular embodiment, using a simple rule-of-mixtures approach, the 1:1 dibasic ester blend:DMSO mixture has Hansen solubility parameters of D=17.5, δP=12.55, δH=7.6, which are nearly identical to that of NMP; δD=18.0, δP=12.3, δH=7.2. Compared to NMP and DMF, the 1:1 mixture of IRIS+DMSO has lower health risks as well as a higher boiling point which allows a larger range of solution processing/reaction conditions with CNTs. Furthermore, IRIS and DMSO solubilize a wide range of monomer and polymer systems, which allow for novel CNT+polymer composite synthesis or formulation

Accordingly, when the graphitic carbon (e.g., CNT) is dispersed in the solvents described herein, a polymer-based nano-composite, where the carbon nanotubes is uniformly dispersed, is obtained by dissolving the polymer materials in the resultant dispersion liquid.

The graphitic carbon described herein may be selected from ones having multilayer structures (multi-walled carbon nanotubes, called MWNT) and ones having single layer structures (single-walled carbon nanotubes, called SWNT) depending on the purposes. The single-walled carbon nanotubes are preferably used in the invention.

The method for producing the SWNT is not particularly limited, and may be produced under several method such as laser deposition methods, thermal decomposition method using a catalyst, vapor growth method, arc discharge method, a laser vaporization method, thermal carbon monoxide decomposition method, template method having the steps of inserting organic molecules into fine pores and thermally decomposing the molecules, or fullerene metal co-deposition method and/or a high-pressure carbon monoxide method.

In one embodiment, solvent blend comprises one or more co-solvents. The co-solvent is chosen from one of the following components (a through h), below. In another embodiment, the co-solvent is a co-solvent blend chosen from at least one component (a through h), below, typically, two or more components.

a) DMSO

b) a first blend of: dialkyl methylglutarate, dialkyl ethylsuccinate and, optionally, dialkyl adipate;

c) a second blend of: dialkyl adipate, dialkyl glutarate and dialkyl succinate;

d) a dioxolane compound of formula I:

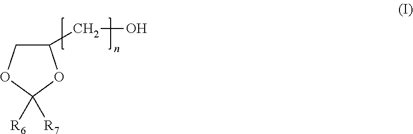

wherein R₆ and R₇, which may be identical or different, is individually a hydrogen, an alkyl group, an alkenyl group, a phenyl group, wherein n is an integer of from 1 to 10;

e) a compound or mixture of compounds having formula (II):

R₃OOC-A-CONR₄R₅ (II)

wherein R₃ is a group chosen from saturated or unsaturated, linear or branched, optionally cyclic, optionally aromatic hydrocarbon-based groups comprising an average number of carbon atoms ranging from 1 to 36; wherein R₄ and R₅, which are identical or different, are groups chosen from saturated or unsaturated, linear or branched, optionally cyclic, optionally aromatic, optionally substituted hydrocarbon-based groups comprising an average number of carbon atoms ranging from 1 to 36, it being possible for R₄ and R₅ to optionally together form a ring, that is optionally substituted and/or that optionally comprises a heteroatom; and wherein A is a linear or branched divalent alkyl group comprising an average number of carbon atoms ranging from 2 to 12, typically from 2 to 4;

f) an alkyldimethylamine;

g) a C₁-C₄ alcohol; and

h) any combination thereof.

In one embodiment, the a C₁-C₄ alcohol is chosen from t-butyl alcohol, butyl alcohol, iso-propyl alcohol, or propyl alcohol. In one typical embodiment, the C₁-C₄ alcohol is iso-propyl alcohol.

In one embodiment, the solvent blend comprises (i) one or a (ii) blend of dibasic esters. In one embodiment, the blend comprises adducts of alcohol and linear diacids, the adducts having the formula R₁-OOC-A-COO-R₂ wherein R₁ and/or R₂ comprise, individually, a C₁-C₁₂ alkyl, more typically a C₁-C₈ alkyl, and A comprises a mixture of —(CH₂)₄—, —(CH₂)₃, and —(CH₂)₂-. In another embodiment, R₁ and/or R₂ comprise, individually, a C₄-C₁₂ alkyl, more typically a C₄-C₈ alkyl. In one embodiment, R₁ and R₂ can individually comprise a hydrocarbon group originating from fusel oil. In one embodiment, R₁ and R₂ individually can comprise a hydrocarbon group having 1 to 8 carbon atoms. In one embodiment, R₁ and R₂ individually can comprise a hydrocarbon group having 5 to 8 carbon atoms. In another embodiment, A comprises a least one, typically at least two, of: —(CH₂)₄—, —CH₂CH₂CH(CH₃)—, —CH₂CH(C₂H₅)—, —(CH₂)₄—, —CH₂CH₂CH(CH₃)—, or —CH₂CH(C₂H₅)-.

In one embodiment, the blend comprises adducts of alcohol and branched or linear diacids, the adducts having the formula R₁-OOC-A-COO-R₂ wherein R₁ and/or R₂ comprise, individually, a C₁-C₁₂ alkyl, more typically a C₁-C₈ alkyl, and A comprises a mixture of —(CH₂)₄—, —CH₂CH₂CH(CH₃)-, and —CH₂CH(C₂H₅)-. In another embodiment, R₁ and/or R₂ comprise, individually, a C₄-C₁₂ alkyl, more typically a C₄-C₈ alkyl. It is understood that the acid portion may be derived from such dibasic acids such as adipic, succinic, glutaric, oxalic, malonic, pimelic, suberic and azelaic acids, as well as mixtures thereof.

The dibasic esters of the present invention can be obtained by a process comprising an “esterification” stage by reaction of a diacid of formula HOOC-A-COOH or of a diester of formula MeOOC-A-COOMe with a branched alcohol or a mixture of alcohols. The reactions can be appropriately catalyzed. Use is preferably made of at least 2 molar equivalents of alcohols per diacid or diester. The reactions can, if appropriate, be promoted by extraction of the reaction by-products and followed by stages of filtration and/or of purification, for example by distillation.

The diacids in the form of mixtures can in particular be obtained from a mixture of dinitrile compounds in particular produced and recovered in the process for the manufacture of adiponitrile by double hydrocyanation of butadiene. This process, used on a large scale industrially to produce the greater majority of the adiponitrile consumed worldwide, is described in numerous patents and works. The reaction for the hydrocyanation of butadiene results predominantly in the formulation of linear dinitriles but also in formation of branched dinitriles, the two main ones of which are methylglutaronitrile and ethylsuccinonitrile. The branched dinitrile compounds are separated by distillation and recovered, for example, as top fraction in a distillation column, in the stages for separation and purification of the adiponitrile. The branched dinitriles can subsequently be converted to diacids or diesters (either to light diesters, for a subsequent transesterification reaction with the alcohol or the mixture of alcohols or the fusel oil, or directly to diesters in accordance with the invention).

Dibasic esters may be derived from one or more by-products in the production of polyamide, for example, polyamide 6,6. In one embodiment, the cleaning composition comprises a blend of linear or branched, cyclic or noncyclic, C₁-C₂₀ alkyl, aryl, alkylaryl or arylalkyl esters of adipic diacids, glutaric diacids, and succinic diacids. In another embodiment, the cleaning composition comprises a blend of linear or branched, cyclic or noncyclic, C₁-C₂₀ alkyl, aryl, alkylaryl or arylalkyl esters of adipic diacids, methylglutaric diacids, and ethylsuccinic diacids

Generally, polyamide is a copolymer prepared by a condensation reaction formed by reacting a diamine and a dicarboxylic acid. Specifically, polyamide 6,6 is a copolymer prepared by a condensation reaction formed by reacting a diamine, typically hexamethylenediamine, with a dicarboxylic acid, typically adipic acid.

In one embodiment, the blend of dibasic esters can be derived from one or more by-products in the reaction, synthesis and/or production of adipic acid utilized in the production of polyamide, the cleaning composition comprising a blend of dialkyl esters of adipic diacids, glutaric diacids, and succinic diacids (herein referred to sometimes as “AGS” or the “AGS blend”).

In one embodiment, the blend of esters is derived from by-products in the reaction, synthesis and/or production of hexamethylenediamine utilized in the production of polyamide, typically polyamide 6,6. The cleaning composition comprises a blend of dialkyl esters of adipic diacids, methylgiutaric diacids, and ethylsuccinic diacids (herein referred to sometimes as “MGA”, “MGN”, “MGN blend” or “MGA blend”).

In certain embodiments, the dibasic ester blend comprises:

a diester of formula I:

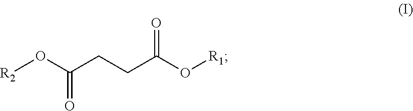

a diester of formula II:

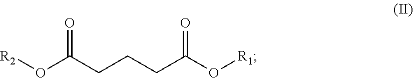

and

a diester of formula III:

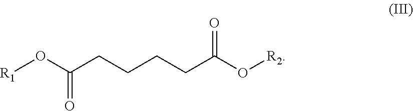

R₁ and/or R₂ can individually comprise a hydrocarbon having from about 1 to about 8 carbon atoms, typically, methyl, ethyl, propyl, isopropyl, butyl, isobutyl, n-butyl, isoamyl, hexyl, heptyl or octyl. In such embodiments, the blend typically comprises (by weight of the blend) (i) about 15% to about 35% of the diester of formula I, (ii) about 55% to about 70% of the diester of formula II, and (iii) about 7% to about 20% of the diester of formula Ill, and more typically, (i) about 20% to about 28% of the diester of formula I, (ii) about 59% to about 67% of the diester of formula II, and (iii) about 9% to about 17% of the diester of formula Ill. The blend is generally characterized by a flash point of 98° C., a vapor pressure at 20° C. of less than about 10 Pa, and a distillation temperature range of about 200-300° C. Mention may also be made of Rhodiasolv® RPDE (Rhodia Inc., Cranbury, N.J.); Rhodiasolv® DIB (Rhodia Inc., Cranbury, N.J.) and Rhodiasolv® DEE (Rhodia Inc., Cranbury, N.J.).

In certain other embodiments, the dibasic ester blend comprises:

a diester of the formula IV:

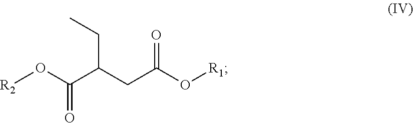

a diester of the formula V:

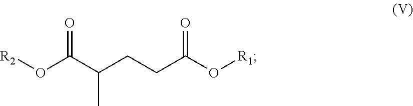

and, optionally,

a diester of the formula VI:

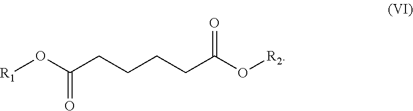

R₁ and/or R₂ can individually comprise a hydrocarbon having from about 1 to about 8 carbon atoms, typically, methyl, ethyl, propyl, isopropyl, butyl, isobutyl, n-butyl, isoamyl, hexyl, heptyl, or octyl. In such embodiments, the blend typically comprises (by weight of the blend) (i) from about 5% to about 30% of the diester of formula IV, (ii) from about 70% to about 95% of the diester of formula V, and (iii) from about 0% to about 10% of the diester of formula VI. More typically, the blend typically comprises (by weight of the blend): (i) from about 6% to about 12% of the diester of formula IV, (ii) from about 86% to about 92% of the diester of formula V, and (iii) from about 0% to about 4% of the diester of formula VI.

Most typically, the blend comprises (by weight of the blend): (i) about 8-10% of the diester of formula IV, (ii) about 87-90% of the diester of formula V, and (iii) about 0-1% of the diester of formula VI. The blend is generally characterized by a flash point of of 98° C., a vapor pressure at 20° C. of less than about 10 Pa, and a distillation temperature range of about 200-275° C. Mention may be made of Rhodiasolv® IRIS and Rhodiasolv® DEE/M, manufactured by Rhodia Inc. (manufactured by Rhodia Inc., Cranbury, N.J.).

In one embodiment, the dibasic ester blend comprises one or more of any of the dibasic esters of: formula (I), formula (II), formula (III), formula (IV), formula (V), and/or formula (VI), in any percentage.

In another embodiment, the solvent blend or solvent blend can include other solvents or mixtures thereof, including but not limited to aliphatic or acyclic hydrocarbons solvents, halogenated solvents, aromatic hydrocarbon solvents, cyclic terpenes, unsaturated hydrocarbon solvents, halocarbon solvents, polyols, alcohols including water-soluble alcohols, ketones or aldehydes such as ethanol, methanol, 1- or 2-propanol, tert-butanol, acetone, methyl ethyl ketone, acetaldehyde, propionaldehyde, ethylene glycol, propylene glycol, alkoxy ethylene glycols and propylene glycols such as 2-methoxyethanol, 2-butoxyethanol, diethyleneglycol, 2-ethoxyethanol, and the like.

The dioxane compound utilized as the solvent blend or in the solvent blend as described herein includes those of formula (I), below:

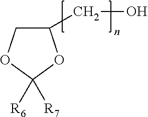

in which: R₆ and R₇, which are identical or different, represent hydrogen or a C₁- C₁₄ group or radical. In one embodiment, R₆ and R₇ are individually selected from an alkyl group, alkenyl group or phenyl radical. In some embodiments, “n” is an integer of 1, 2, 3, 4, 5, 6, 7, 8, 9, 10, 11 or 12. Typically, “n” is an integer from about 1 to 4. More typically, “n” is 1 or 2.

In one particular embodiment, R₆ and R₇ are radicals individually selected from methyl, ethyl, n-propyl, isopropyl or isobutyl radical.

In one embodiment the dioxolane compound is of formula (I) is 2,2- dimethyl-1,3-dioxolane-4-methanol. In another embodiment, the dioxolane compound of formula (I) is 2,2-diisobutyl-1,3-dioxolane-4-methanol (also known by the acronym IIPG, for the synonym 1-isobutyl-isopropylidene glycerol).

In one embodiment, a compound utilized as the solvent blend or as a component in the solvent blend is a compound of general formula (II):

R₃OOC-A-CONR₄R₅ (II),

According to one embodiment, the expression “compound” denotes any compound corresponding to the general formula (II). In other embodiments, the term “compound” also refers to mixtures of several molecules corresponding to general formula (II). It may therefore be a molecule of formula (II) or a mixture of several molecules of formula (II), wherein both fall under the definition of the term “compound” when referring to formula (II).

The R₃, R₄ and R₅ groups can be, in some embodiments, identical or, in other embodiment, different. In one embodiment, may be groups chosen from C₁-C₂₀ alkyl, aryl, alkaryl or arylalkyl groups or the phenyl group. In another embodiment, may be groups chosen from C₁-C₁₂ alkyl, aryl, alkaryl or arylalkyl groups or the phenyl group. Mention is made especially of Rhodiasolv® PolarClean (Manufactured by Rhodia Inc. of Cranbury, N.J.). The R₄ and R₅ groups may optionally be substituted. In one particular embodiment, the groups are substituted with hydroxyl groups.

In one embodiment, R₃ group is chosen from methyl, ethyl, propyl, isopropyl, n-butyl, isobutyl, n-pentyl, isopentyl, isoamyl, n-hexyl, cyclohexyl, 2-ethylbutyl, n-octyl, isooctyl, 2-ethylhexyl, tridecyl groups.

R₄ and R₅ groups, which are identical or different, in one embodiment, may especially be chosen from methyl, ethyl, propyl (n-propyl), isopropyl, n-butyl, isobutyl, n-pentyl, amyl, isoamyl, hexyl, cyclohexyl or hydroxyethyl groups. The R₄ and R₅ groups may also be such that they form, together with the nitrogen atom, a morpholine, piperazine or piperidine group. According to some embodiments, R₄ and R₅ are each methyl, or R₄ and R₅ are each ethyl, or R₄ and R₅ are each hydroxyethyl.

According to one embodiment, if A comprises a linear group of formula -- CH₂-- CH₂-- and/or of formula -- CH₂-- CH₂-- CH₂-- CH₂-- and/or of formula -- (CH₂)₈-- then it is a mixture of A groups. According to one particular embodiment, if A is linear, then it is a mixture of A groups, for example a mixture of two or three -- CH₂-- CH₂-- (ethylene); -- CH₂-- CH₂-- CH₂-- (n-propylene); and -- CH₂-- CH₂-- CH₂-- CH₂-- (n-butylene) groups (or isomers thereof).

According to a first particular embodiment of the invention, the A group is a divalent linear alkyl group chosen from the groups of the following formulae: -- CH₂-- CH₂-- (ethylene); -- CH₂-- CH₂-- CH₂-- (n-propylene); CH₂-- CH₂-- CH₂-- CH₂-- (n-butylene), and mixtures thereof.

According to such embodiment, the compound is a mixture according to the following mixture of molecules:

R₃OOC-(CH₂)₂-CONR₄R₅;

R₃OOC-(CH₂)₃-CONR₄R₅ ; and

R₃OOC-(CH₂)₄-CONR₄R₅

According to another particular embodiment of the invention, the A group is a divalent branched alkyl group chosen from the groups of the following formulae: --CH(CH₃)-- CH₂--CH₂--; --CH(C₂H₅)--CH₂--; and, optionally, -- CH₂-- CH₂-- CH₂-- CH₂--; as well as mixtures thereof.

According to such embodiment, the compound is a mixture according to the following mixture of molecules:

R₃OOC-CH(CH₃)(CH₂)₂-CONR₄R₅;

R₃OOC-CH(C₂H₅)CH₂-CONR₄R₅ ; and, optionally,

R₃OOC-(CH₂)₄-CONR₄R₅

According to one particular variant in this first embodiment, the compound of the invention is chosen from the following compounds:

MeOOC-- CH₂-- CH₂--CONMe₂;

MeOOC-- CH₂-- CH₂-- CH₂--CONMe₂;

MeOOC-- CH₂-- CH₂-- CH₂--CONMe₂, as a mixture with MeOOC--CH₂-- CH₂--CH₂-- CH₂--CON Me₂ and/or with MeOOC-- CH₂-- CH₂--CON Me₂-

According to another embodiment of the invention, the A group is a divalent branched alkylene group having one of the following formulae (IIa), (IIIb), (IIc), (IIIa) and (IIIb), or a mixture of at least two groups chosen from the groups of formulae (IIa), (IIb) and (IIc) or from the groups of formulae (IIIa) and (IIIb), or a mixture of at least two groups, one chosen from the groups of formulae (IIa), (IIb) and (IIc) and the others chosen from the groups of formulae (IIIa) and (IIIb):

--(CHR₉)_{y}--(CHR₈)ₓ--(CHR₉)_{z}--CH₂--CH₂-- (IIa)

--CH₂--CH₂--(CHR₉)_{z}--(CHR₈)ₓ--(CHR₉)_{y}-- (IIb)

--(CHR₉)_{z}-- CH₂--(CHR₈)ₓ--CH₂--(CHR₉)_{y}-- (IIc)

--(CHR₉)_{y}--(CHR₈)ₓ--(CHR₉)_{z}--CH₂-- (IIIa)

-- CH₂--(CHR₉)z--(CHR₈)ₓ--(CHR₉)_{y}-- (IIIb)

where:

x is an integer greater than 0;

y is an average integer greater than or equal to 0;

z is an average integer greater than or equal to 0; R₈, which is identical or different, is a C₁-C₆, preferably C₁-C₄, alkyl group; and R₉, which is identical or different, is a hydrogen atom or a C₁-C₆, preferably C₁-C₄, alkyl group. In this particular embodiment, the A group is preferably a group such that y and z are 0.

In one embodiment, in formula (IIa) and/or in the formula (IIb): x is 1; y and z are 0; R₈ is methyl.

In another embodiment, in the formula (IIIa) and/or in the formula (IIIb): x is 1; y and z are 0; R₈ is ethyl.

According to another embodiment, the compound of the invention is chosen from the following compounds, and mixtures thereof:

MeOOC-A_{MG}-CONMe₂;

MeOOC-A_{ES}-CONMe₂;

PeOOC-A_{MG}-CONMe₂;

PeOOC-A_{ES}-CONMe₂;

CycloOOC-A_{MG}-CONMe₂;

CycloOOC-A_{ES}-CONMe₂;

EhOOC-A_{MG}-CONMe₂;

EhOOC-A_{ES}-CONMe₂;

PeOOC-A_{MG}-CONEt₂;

PeOOC-A_{ES}-CONEt₂;

CycloOOC-A_{MG}-CONEt₂;

CycloOOC-A_{ES}-CONEt₂;

BuOOC-A_{MG}-CONEt₂;

BuOOC-A_{ES}-CONEt₂;

BuOOC-A_{MG}-CONMe₂;

BuOOC-A_{ES}-CONMe₂;

EtBuOOC-A_{MG}-CONMe₂;

EtBuOOC-A_{ES}-CONMe₂;

n-HeOOC-A_{MG}-CONMe₂;

n-HeOOC-A_{ES}-CONMe₂;

where

A_{MG} represents an MGₐ group of formula --CH(CH₃)--CH₂--CH₂--, or MG_{b} group of formula --CH₂--CH₂--CH(CH₃)-- or a mixture of. MGₐ and MG_{b} groups;

A_{ES} represents an ESₐ group of formula --CH(C₂H₅)--CH₂--, or ES_{b} group of formula --CH₂--CH(C₂H₅)-- or a mixture of ESₐ and ES_{b} groups;

Pe represents a pentyl group, preferably an isopentyl or isoamyl group;

Cyclo represents a cyclohexyl group;

Eh represents a 2-ethylhexyl group;

Bu represents a butyl group, preferably an n-butyl or tert-butyl group;

EtBu represents an ethylbutyl group; and

n-He represents an n-hexyl group.

It is mentioned that according to one particular embodiment, the compound of the invention is a compound different from the following compounds:

MeOOC--CHEt-CH₂--CON Me₂;

MeOOC--CH₂--CH(CH₃)--CH₂--CONMe₂;

MeOOC--CH₂--CH₂--CH₂--CONMe₂; and

MeOOC--CH₂--CH₂--CONMe₂;

if the latter are not used as a mixture with other compounds corresponding to formula (II).

It is mentioned that according to one even more particular variant of one or the other of the particular embodiments of the invention, the compound of the invention is a novel compound of the invention, different from the following compounds or mixtures, if the latter, individually, are not used as a mixture with other compounds corresponding to formula (II):

MeOOC--CHEt-CH₂--CONMe₂;

MeOOC--CH₂--CH(CH₃)--CH₂--CONMe₂;

MeOOC--CH₂--CH₂--CH₂--CONMe₂;

MeOOC--CH₂--CH₂--CONMe₂;

mixture of PhOOC--CH(CH₃)--CH₂--CONEt₂ and PhOOC--CH₂--CH₂-- CH₂--CONEt₂;

EtOOC--CH(CH₃)--CH₂--CONEt₂;

MeOOC--CH(CH₃)--CH₂--CONEt₂;

Me-CH(OMe)-OOC--CH(CH₃)--CH₂--CONEt₂;

Cyclohexyl-OOC--CH(CH₃)--CH₂--CONEt₂;

Ph-CH₂OOC--CH(CH₃)--CH₂--CONEt₂;

p-cresyl-OOC--CH(CH₃)--CH₂--CONEt₂;

mixture of EtOOC--CHEt-CH₂--CONEt₂, EtOOC--CH(CH₃)--CH₂--CH₂--

CONEt₂ and EtOOC--CH₂--CH₂--CH₂--CH₂--CONEt₂; and

MeOOC--CH₂--CH(CH₃)--CH₂--CONH(n-butyl).

It is mentioned that according to one even more particular variant of one or the other of the particular embodiments of the invention, the compound of the invention is a novel compound of the invention, different from the following compounds or mixtures, if the latter, individually, are not used as a mixture with other compounds corresponding to formula (II):

C₄H₉--OOC--CH₂--CH₂--CONEt₂

C₆H₁₃--OOC--(CH₂)₈--CON(C₃H₇)₂

C₈H₁₇--OOC--(CH₂)₈--CON(C₄H₉)₂

C₈H₁₇--OOC--(CH₂)₈--CON(C₈H₁₇)₂.

In one embodiment, it is possible to use the following compounds as a mixture with other compounds corresponding to formula (II):

MeOOC--CHEt-CH₂--CONMe₂;

MeOOC--CH₂--CH(CH₃)--CH₂--CONMe₂;

MeOOC--CH₂--CH₂--CH₂--CONMe₂;

MeOOC--CH₂--CH₂--CONMe₂;

mixture of PhOOC--CH(CH₃)--CH₂--CONEt₂ and PhOOC--CH₂--CH₂-- CH₂--CONEt₂;

EtOOC--CH(CH₃)--CH₂--CONEt₂;

MeOOC--CH(CH₃)--CH₂--CONEt₂;

Me-CH(OMe)-OOC--CH(CH₃)--CH₂--CONEt₂;

Cyclohexyl-OOC--CH(CH₃)--CH₂--CONEt₂;

Ph-CH₂OOC--CH(CH₃)--CH₂--CONEt₂;

p-cresyl-OOC--CH(CH₃)--CH₂--CONEt₂;

mixture of EtOOC--CHEt-CH₂--CONEt₂, EtOOC--CH(CH₃)--CH₂--CH₂-- CONEt₂ and EtOOC--CH₂--CH₂--CH₂--CH₂--CONEt₂;

MeOOC--CH₂--CH(CH₃)--CH₂--CONH(n-butyl);

C₄H₉--OOC--CH₂--CH₂--CONEt₂;

C₆H₁₃--OOC--(CH₂)₈--CON(C₃H₇)₂;

C₈H₁₇--OOC--(CH₂)₈--CON(C₄H₉)₂; and

C₈H₁₇--OCC--(CH₂)₈--CON(C₈H₁₇)₂.

It is mentioned that according to one still more particular variant of one or the other of the particular embodiments of the invention, the following compounds or mixtures are not used:

MeOOC--CHEt-CH₂--CONMe₂;

MeOOC--CH₂--CH(CH₃)--CH₂--CONMe₂;

MeOOC--CH₂--CH₂--CH₂--CONMe₂;

MeOOC--CH₂--CH₂--CONMe₂;

mixture of PhOOC--CH(CH₃)--CH₂--CONEt₂ and PhOOC--CH₂--CH₂-- CH₂--CONEt₂;

EtOOC--CH(CH₃)--CH₂--CONEt₂;

MeOOC--CH(CH₃)--CH₂--CONEt₂;

Me-CH(OMe)-OOC--CH(CH₃)--CH₂--CONEt₂;

Cyclohexyl-OOC--CH(CH₃)--CH₂--CONEt₂;

Ph-CH₂OOC--CH(CH₃)--CH₂--CONEt₂;

p-cresyl-OOC--CH(CH₃)--CH₂--CONEt₂;

mixture of EtOOC--CHEt-CH₂--CONEt₂, EtOOC--CH(CH₃)--CH₂--CH₂-- CONEt₂ and EtOOC--CH₂--CH₂--CH₂--CH₂--CONEt₂; and

MeOOC--CH₂--CH(CH₃)--CH₂--CONH(n-butyl).

It is mentioned that according to one still more particular variant of one or the other of the particular embodiments of the invention, the following compounds or mixtures are not used:

C₄H₉-OOC--CH₂--CH₂--CONEt₂;

C₆H₁₃--OOC--(CH₂)₈--CON(C₃H₇)₂;

C₈H₁₇--OOC--(CH₂)₈--CON(C₄H₉)₂,

C₈H₁₇--OOC--(CH₂)₈--CON(C₈H₁₇)₂.

According to one embodiment, the esteramide has a melting point that is less than or equal to 20° C., preferably 5° C., preferably 0° C.

In one particular embodiment, R₃ is a group chosen from saturated or unsaturated, linear or branched, optionally cyclic, optionally aromatic hydrocarbon-based groups comprising an average number of carbon atoms ranging from 1 to 36. R₄ and R₅, which are identical or different, are groups chosen from saturated or unsaturated, linear or branched, optionally cyclic, optionally aromatic, optionally substituted hydrocarbon-based groups comprising an average number of carbon atoms ranging from 1 to 36. It is possible for R₄ and R₅ to form a ring together, and in some embodiment, the ring is optionally substituted and/or optionally comprises a heteroatom. In some embodiments, A is a linear or branched divalent alkyl group comprising an average number of carbon atoms ranging from 1 to 20, in some embodiments, from 2 to 12, in other embodiments, from 2 to 8, in yet other embodiments, from 2 to 4.

In one embodiment, the solvent blend comprises amides, alkyl amides, or dialkyl amides. In an alternative embodiment, one component in the solvent blend comprises an amide, alkyl amide, and/or dialkyl amide. In one particular embodiment, the solvent blend or solvent blend is alkyldimethylamide (ADMA). The alkyl group is a C₁-C₅₀ alkyl group, more typically a C₂-C₃₀ alkyl group, even more typically, a C₂-C₂₀ alkyl group. In one particular embodiment, the alkyldimethylamide is N,N-dimethyldecanamide (miscibility 0.034%) or N,N-dimethyloctanamide (miscibility 0.43%), or mixtures thereof. Mention is made especially of the compounds sold by Rhodia, Rhodiasolv® ADMA810 and Rhodiasolv® ADMA10.

The solvent blend typically comprises from about 25-75% by weight solvent blend of the dibasic ester blend; and from about 25-75% by weight solvent blend of the dimethyl sulfoxide. The solvent blend, in yet another embodiment, comprises from about 40-60% by weight solvent blend of the dibasic ester blend; and from about 40-60% by weight solvent blend of the dimethyl sulfoxide.

Experiments:

A dispersion of MWCNTs (Nanocyl®) was created by adding 0.1 wt % of MWCNTs in a 1:1 weight ratio of IRIS to DMSO, in a 1:1 weight ratio of IRIS to H₂O, in a 1:1 weight ratio of IRIS to DMF, and in a 1:1 weight ratio of IRIS to NMP. Each solution was vortexed, sonicated for 15 minutes, and then allowed to sit for more than 96 hours. Images of each solution afterwards did not show any difference amongst each solvent blend; all of the MWCNTs were in an aggregated, sedimented state. After 15 minutes of sonication (˜55 kHz) it was observed that there was a dramatic improvement in dispersion of the 1:1 IRIS:DMSO solution compared to all others; the H₂O, DMF, and NMP solutions, respectively, showed large aggregates of MWCNTs floating in solution, while the 1:1 IRIS:DMSO solution possess the expected dark black color of a dispersion of MWCNTs. After at least 96 hours, the MWCNTs sedimented to the bottom of their respective vials, however the 1:1 IRIS:DMSO solution showed the greatest amount of solubilized MWCNTs. This improved dispersion will enable novel synthesis and formulation methods that could yield improved conductivity of CNTs in composite materials for next generation organic electronic devices.

To demonstrate the viability of this solvent blend for MWCNT composite formulation, a 10 mL solution of 0.1 wt % MWCNT in 1:1 IRIS:DMSO was prepared in the same fashion as highlighted above; vortexing, 15 min sonication, and then added to 9 mL of a 5 wt % polyacrylonitrile (PAN) solution in DMSO. This solution formed a stable dispersion of PAN and MWCNTs. This PAN/MWCNT solution was drawn into a syringe and expunged into a water bath, forming PAN/MWCNT composite fibers. This is a demonstration of a viable solution for processible, polymer/carbon nanotube composite fiber formation aided by the increased solubility of MWCNTs in the 1:1 IRIS:DMSO solvent blend.

The invention is capable of considerable modification, alteration and equivalents in form and function. The depicted and described preferred embodiments of the invention are exemplary only and are not exhaustive of the scope of the invention. Consequently, the invention is intended to be limited only by the spirit and scope of the appended claims, giving full cognizance to equivalents in all respects.

What is claimed is:

1. A method for preparing a dispersion of graphitic carbon, comprising:
obtaining graphitic carbon; and
contacting the graphitic carbon with a solvent blend comprising (i) a dibasic ester blend and (ii) a compound selected from the group consisting of an organosulfur compound, tetrahydrofuran, ethyl acetate, acetone, acetonitrile, dimethyl sulfoxide and any combination thereof.

2. The method of claim 1 wherein the organosulfur compound is dimethyl sulfoxide.

3. A method for preparing a dispersion of graphitic carbon, comprising:
obtaining graphitic carbon; and
contacting the graphitic carbon with a solvent blend comprising a dibasic ester blend and dimethyl sulfoxide.

4. The method of claim 1 wherein the dibasic ester blend is selected from dialkyl methylglutarate, dialkyl ethylsuccinate, dialkyl adipate, dialkyl succinate, dialkyl glutarate or any combination thereof.

5. The method of claim 1 wherein the dibasic ester blend comprises a branched dibasic ester and at least one of dialkyl methylglutarate, dialkyl ethylsuccinate, dialkyl adipate, dialkyl succinate or dialkyl glutarate.

6. The method of claim 1 wherein the step of contacting the graphitic carbon with a solvent blend comprises mixing the graphitic carbon in the solvent blend, thereby dispersing the graphitic carbon.

7. The method of claim 1 wherein the graphitic carbon is selected from graphite, graphene, fullerenes, chemically modified fullerenes, carbon nanotubes, single- walled carbon nanotubes or multi-walled carbon nanotubes.

8. The method of claim 1 wherein the solvent blend comprises
from about 25-75% by weight solvent blend of the dibasic ester blend; and
from about 25-75% by weight solvent blend of the dimethyl sulfoxide.

9. The method of claim 8 wherein the solvent blend further comprises one or more co-solvents

10. The method of claim 9 wherein the co-solvent is selected from the group consisting of:
a) a dioxolane compound of formula I: 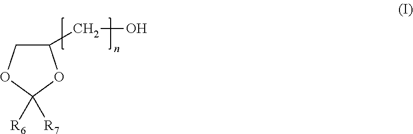
wherein R₆ and R₇, which may be identical or different, is individually a hydrogen, an alkyl group, an alkenyl group, a phenyl group, wherein n is an integer of from 1 to 10;
b) a compound or mixture of compounds having formula (II):
R₃OOC-A-CONR₄R₅ (II),
wherein R₃ is a group chosen from saturated or unsaturated, linear or branched, optionally cyclic, optionally aromatic hydrocarbon-based groups comprising an average number of carbon atoms ranging from 1 to 36;
wherein R₄ and R₅, which are identical or different, are groups chosen from saturated or unsaturated, linear or branched, optionally cyclic, optionally aromatic, optionally substituted hydrocarbon-based groups comprising an average number of carbon atoms ranging from 1 to 36; and
wherein A is a linear or branched divalent alkyl group comprising an average number of carbon atoms ranging from 2 to 12;
c) an alkyldimethylamine; and
d) any combination thereof.

11. The method of claim 3 wherein the solvent blend comprises
from about 40-60% by weight solvent blend of the dibasic ester blend; and
from about 40-60% by weight solvent blend of the dimethyl sulfoxide.

12. A dispersion of graphitic carbon comprising :
a) 0.001 to 75 wt % graphitic carbon, based on weight of dispersion; and
b) a solvent blend comprising:
from about 10-90% by weight solvent blend of the dibasic ester blend; and
from about 10-90% by weight solvent blend of the dimethyl sulfoxide.

13. The dispersion of claim 12 wherein the dispersion of graphitic carbon comprises:
a) 0.1 to 25 wt % graphitic carbon, based on weight of dispersion; and
b) a solvent blend comprising:
from about 25-75% by weight of solvent blend of the dibasic ester blend; and
from about 25-75 wt % by weight solvent blend of the dimethyl sulfoxide.

14. The dispersion of claim 12 wherein the solvent blend comprises:
from about 40-60% by weight solvent blend of the dibasic ester blend; and
from about 40-60% by weight solvent blend of the dimethyl sulfoxide.

15. The dispersion of claim 12 wherein the dibasic ester blend is selected from dialkyl methylgiutarate, dialkyl ethylsuccinate, dialkyl adipate, dialkyl succinate, dialkyl glutarate or any combination thereof.

16. The dispersion of claim 12 wherein the dibasic ester blend comprises a branched dibasic ester and at least one of dialkyl methylglutarate, dialkyl ethylsuccinate, dialkyl adipate, dialkyl succinate or dialkyl glutarate.

17. The dispersion of claim 12 wherein the graphitic carbon is selected from graphite, graphene, fullerenes, chemically modified fullerenes, carbon nanotubes, single-walled carbon nanotubes or multi-walled carbon nanotubes.

18. A dispersion of graphitic carbon comprising:
a) 0.01 to 75 wt % graphitic carbon, based on weight of dispersion;
b) a solvent blend comprising:
from about 10-90 wt % by weight solvent blend of the dibasic ester blend;
from about 10-90 wt % by weight solvent blend of the dimethyl sulfoxide; and
c) a co-solvent selected from:
c(i) a dioxolane compound of formula I: 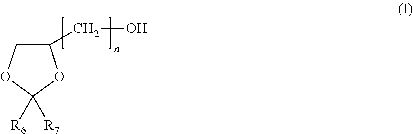
wherein R₆ and R₇, which may be identical or different, is individually a hydrogen, an alkyl group, an alkenyl group, a phenyl group, wherein n is an integer of from 1 to 10;
c(ii) a compound or mixture of compounds having formula (II):
R₃OOC-A-CONR₄R₅ (II),
wherein R₃ is a group chosen from saturated or unsaturated, linear or branched, optionally cyclic, optionally aromatic hydrocarbon-based groups comprising an average number of carbon atoms ranging from 1 to 36;
wherein R₄ and R₅, which are identical or different, are groups chosen from saturated or unsaturated, linear or branched, optionally cyclic, optionally aromatic, optionally substituted hydrocarbon-based groups comprising an average number of carbon atoms ranging from 1 to 36; and
wherein A is a linear or branched divalent alkyl group comprising an average number of carbon atoms ranging from 2 to 12;
c(iii) an alkyldimethylamine; or
c(iv) any combination thereof.

19. A method for preparing a dispersion of graphitic carbon, consisting essentially of the steps of:
obtaining graphitic carbon; and
contacting the graphitic carbon with a solvent blend comprising:
(a) a dibasic ester blend,
(b) dimethyl sulfoxide, and
(c) optionally, a co-solvent, the co-solvent selected from:
c(i) a dioxolane compound of formula I: 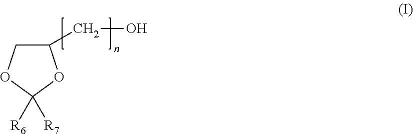
wherein R₆ and R₇, which may be identical or different, is individually a hydrogen, an alkyl group, an alkenyl group, a phenyl group, wherein n is an integer of from 1 to 10;
c(ii) a compound or mixture of compounds having formula (II):
R₃OOC-A-CONR₄R₅ (II),
wherein R₃ is a group chosen from saturated or unsaturated, linear or branched, optionally cyclic, optionally aromatic hydrocarbon-based groups comprising an average number of carbon atoms ranging from 1 to 36;
wherein R₄ and R₅, which are identical or different, are groups chosen from saturated or unsaturated, linear or branched, optionally cyclic, optionally aromatic, optionally substituted hydrocarbon-based groups comprising an average number of carbon atoms ranging from 1 to 36; and
wherein A is a linear or branched divalent alkyl group comprising an average number of carbon atoms ranging from 2 to 12;
c(iii) an alkyldimethylamine; or
c(iv) any combination thereof.

20. A method for chemically modifying graphitic carbon, comprising:
obtaining graphitic carbon;
contacting the graphitic carbon with a solvent blend to create a dispersion, the solvent blend comprising (i) a dibasic ester blend and (ii) a compound selected from the group consisting of an organosulfur compound, tetrahydrofuran, ethyl acetate, acetone, acetonitrile, dimethyl sulfoxide and any combination thereof; and
functionalizing the graphitic carbon.

21. The method of claim 20 wherein the step of functionalizing the graphitic carbon comprises a reaction that (i) covalently disrupts, modifies, or alters the bond configuration of a carbon atom of the graphitic carbon in contact with the solvent blend, or (ii) allows non-covalent physisorption of a chemical moiety that is solubilized or partially solubilized in the solvent blend.

22. The method of claim 20 wherein the organosulfur compound is dimethyl sulfoxide.

23. A method for chemically modifying graphitic carbon, comprising:
obtaining graphitic carbon;
contacting the graphitic carbon with a solvent blend to create a dispersion, the solvent blend comprising a dibasic ester blend and dimethyl sulfoxide (DMSO); and
functionalizing the graphitic carbon through a reaction that (i) covalently disrupts, modifies, or alters the native sp² bond configuration of carbon atoms within a layer of graphitic carbon in contact with the solvent blend, or (ii) allows non-covalent physisorption of any chemical moiety that is solubilized or partially solubilized in the solvent blend.

24. A method for chemically modifying graphitic carbon or preparing functionalized graphitic carbon material comprising the steps of:
obtaining graphitic carbon;
contacting the graphitic carbon with a solvent blend to create a dispersion, the solvent blend comprising:
(a) a dibasic ester blend,
(b) dimethyl sulfoxide (DMSO), and
(c) optionally, a co-solvent, the co-solvent selected from:
c(i) a dioxolane compound of formula I: 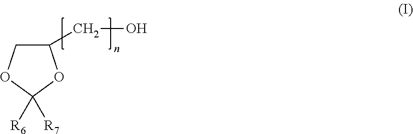
wherein R₆ and R₇, which may be identical or different, is individually a hydrogen, an alkyl group, an alkenyl group, a phenyl group, wherein n is an integer of from 1 to 10;
c(ii) a compound or mixture of compounds having formula (II):
R₃OOC-A-CONR₄R₅ (II),
wherein R₃ is a group chosen from saturated or unsaturated, linear or branched, optionally cyclic, optionally aromatic hydrocarbon-based groups comprising an average number of carbon atoms ranging from 1 to 36;
wherein R₄ and R₅, which are identical or different, are groups chosen from saturated or unsaturated, linear or branched, optionally cyclic, optionally aromatic, optionally substituted hydrocarbon-based groups comprising an average number of carbon atoms ranging from 1 to 36; and
wherein A is a linear or branched divalent alkyl group comprising an average number of carbon atoms ranging from 2 to 12;
c(iii) an alkyldimethylamine; or
c(iv) any combination thereof; and
functionalizing the graphitic carbon.

25. The method of claim 24 wherein the step of functionalizing the graphitic carbon comprises a reaction that (i) covalently disrupts, modifies, or alters the bond configuration of a carbon atom of the graphitic carbon in contact with the solvent blend, or (ii) allows non-covalent physisorption of a chemical moiety that is solubilized or partially solubilized in the solvent blend.
